(19) United States
(12) Patent Application Publication
(10) Pub. No.: US 2010/0200175 A1
(43) Pub. Date: Aug. 12, 2010

(54) WINDOW BLIND ASSEMBLY

(76) Inventor: Shih-Ming Lin, Chiayi Hsien (TW)

Correspondence Address: SCHWABE, WILLIAMSON & WYATT, P.C., 1420 FIFTH, SUITE 3400, SEATTLE, WA, 98101-4010, US

(21) Appl. No.: 12/369,390

(22) Filed: Feb. 11, 2009

(51) Int. Cl. E06B 9/26

(52) U.S. Cl. 160/113

(57) ABSTRACT

A window blind assembly includes a top rail, a drawable primary curtain unit hung from the top rail, and a drawable auxiliary curtain unit hung from the top rail and disposed at one side of the primary curtain unit. The primary curtain unit includes an upper curtain section and a lower curtain section extending downwardly from the upper curtain section and having a light transmittance less than that of the upper curtain section. The auxiliary curtain unit includes an auxiliary curtain that has a light transmittance less than that of the upper curtain section and that has a vertical length less than a combined vertical length of the upper and lower curtain sections. The vertical length of the auxiliary curtain is sufficient to ensure that the auxiliary curtain is able to substantially cover the upper curtain section when the auxiliary curtain and the upper curtain section are lowered.

### BACKGROUND OF THE INVENTION

1. Field of the Invention

The present invention relates to a window blind assembly, more particularly to a window blind assembly including a primary curtain unit and an auxiliary curtain unit.

2. Description of the Related Art

Referring to FIGS. 1 and 2, a conventional window blind assembly is exemplified as a roman blind 1 that includes a top rail 11 adapted to be disposed at a top edge of a window 10, a light-blocking curtain 12 hung from the top rail 11, a first pull cord 13 for drawing up and lowering the light-blocking curtain 12, a light-transmitting curtain 14 hung from the top rail 11 and disposed closer to the window 10 relative to the light-blocking curtain 12, a second pull cord 15 for drawing up and lowering the light-transmitting curtain 14, and a decorative member 16 disposed at a rear wall 111 of the top rail 11.

The light-blocking curtain 12 is made of a fabric having a relatively poor light transmittance, and includes a plurality of vertically disposed drawable segments 121 interconnected in series and capable of being drawn up and lowered by operating the first pull cord 13. The light-transmitting curtain 14 is made of a fabric having a relatively high light transmittance, such as a screen material, and includes a plurality of vertically disposed drawable segments 141 interconnected in series and capable of being drawn up and lowered by operating the second pull cord 15. Since the improvement of the present invention does not reside in the mechanisms of the first and second pull cords 13, 15, further details of the same will be omitted herein for the sake of brevity.

When the light-blocking curtain 12 of the conventional roman blind 1 is fully lowered, the light-blocking curtain 12 can block passing of light through the window 10 into a room. The light-blocking curtain 12 is adapted to be drawn up for natural lighting of a room. When the light-blocking curtain 12 and the light-transmitting curtain 14 are completely drawn up, the light is able to directly pass into the room.

Although the conventional roman blind 1 permits adjusting of an amount of the light passing into the room by drawing up and lowering the light-blocking curtain 12 and the light-transmitting curtain 14, it has the following disadvantages.

First, a large amount of fabric material is needed to manufacture the conventional roman blind 1, because the conventional roman blind 1 includes the light-blocking curtain 12 and the light-transmitting curtain 14 having the same vertical length that is longer than a vertical length of the window 10.

Second, it is relatively strenuous to draw up the light-blocking curtain 12 and the light-transmitting curtain 14 via the first and second pull cords 13, 15. As mentioned above, the vertical lengths of the light-blocking curtain 12 and the light-transmitting curtain 14 are relatively long such that the weights thereof are relatively heavy.

Third, privacy and natural lighting cannot be ensured at the same time. Because sunlight passes into the room obliquely, the light-blocking curtain 12 is required to be drawn up by a greater extent for better natural lighting of the room. However, the privacy of people inside the room cannot be safeguarded at this time.

### SUMMARY OF THE INVENTION

Therefore, an object of the present invention is to provide a window blind assembly that consumes fewer fabrics for manufacturing, that is relatively light to facilitate operation, and that can ensure privacy and natural lighting at the same time.

Accordingly, a window blind assembly of this invention comprises a top rail, a drawable primary curtain unit that is hung from the top rail, and a drawable auxiliary curtain unit that is hung from the top rail and that is disposed at one side of the primary curtain unit. The drawable primary curtain unit includes an upper curtain section and a lower curtain section that extends downwardly from the upper curtain section and that has a light transmittance less than that of the upper curtain section. The drawable auxiliary curtain unit includes an auxiliary curtain that has a light transmittance less than that of the upper curtain section and that has a vertical length less than a combined vertical length of the upper and lower curtain sections. The vertical length of the auxiliary curtain is sufficient to ensure that the auxiliary curtain is able to substantially cover the upper curtain section when the auxiliary curtain and the upper curtain section are lowered.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional roman blind;

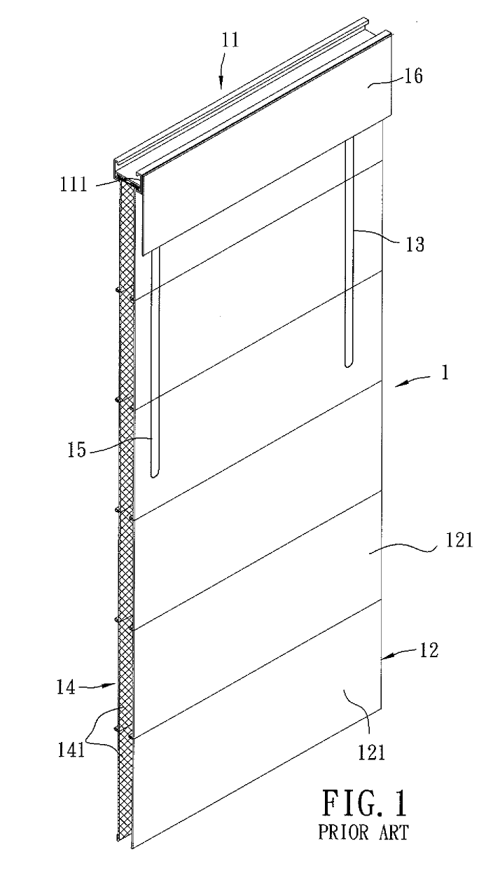

FIG. 2 is a side view of the conventional roman blind;

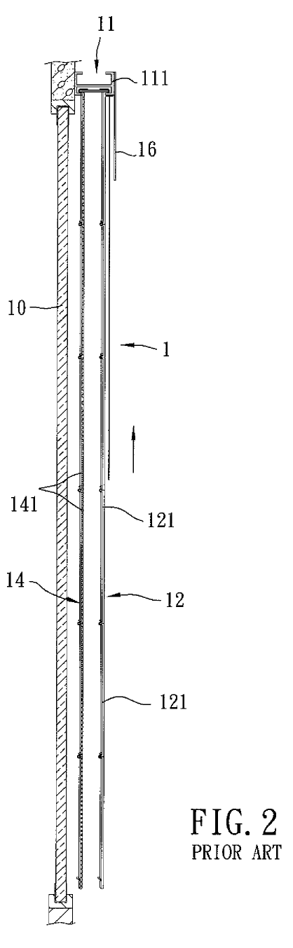

FIG. 3 is a perspective view of the preferred embodiment of a window blind assembly of the present invention;

FIG. 4 is a side view of the preferred embodiment, illustrating a state where an auxiliary curtain of the window blind assembly is fully lowered;

FIG. 5 is an enlarged fragmentary view of FIG. 4 showing a top rail of the window blind assembly; and

FIG. 6 is a side view of the preferred embodiment, illustrating a state where the auxiliary curtain of the window blind assembly is fully drawn up.

### DETAILED DESCRIPTION OF THE PREFERRED EMBODIMENT

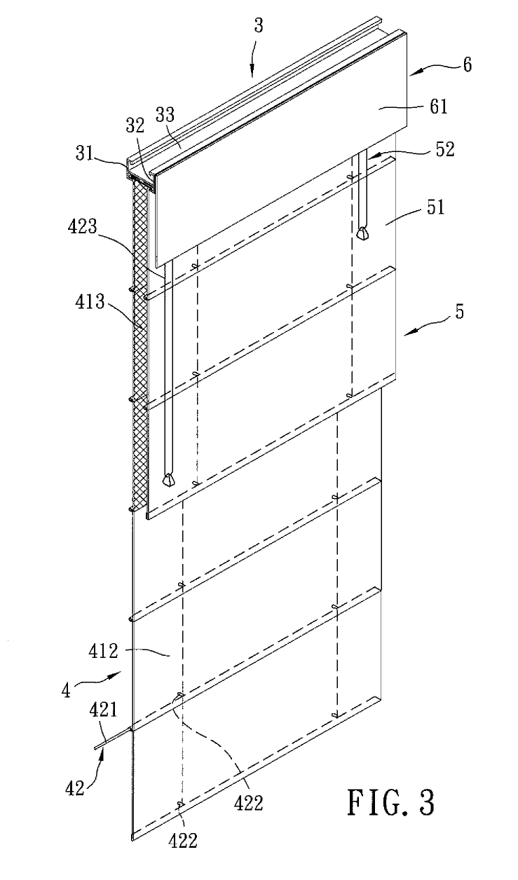

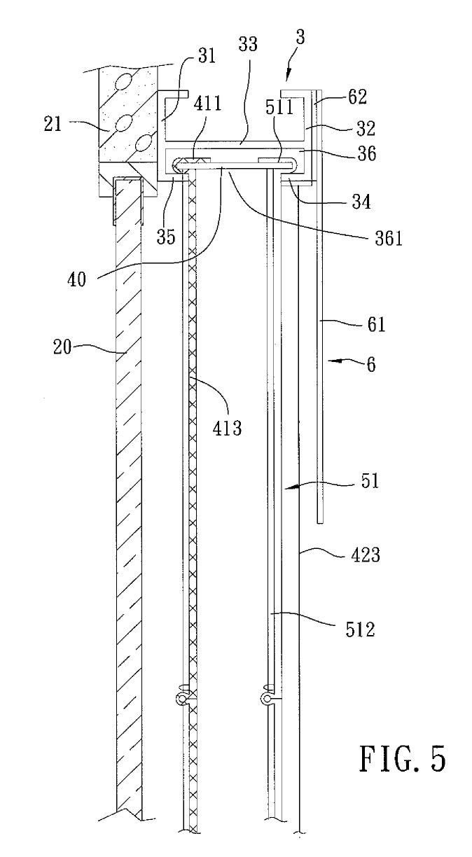

Referring to FIGS. 3 to 5, the preferred embodiment of a window blind assembly of the present invention is shown to be in the form of a roman blind disposed at a wall 21 above a window 20. The roman blind includes a top rail 3 horizontally disposed on the wall 21, a drawable primary curtain unit 4 that is hung from the top rail 3 and that is disposed proximate to the window 20, and a drawable auxiliary curtain unit 5 that is hung from the top rail 3.

The top rail 3 is an extruded aluminum rail and includes: a front wall 31 extending vertically and fixed to the wall 21; a rear wall 32 extending vertically and spaced apart from the front wall 31 in a front-rear direction; two bottom walls 34, 35 extending toward each other from bottom edges of the front and rear walls 31, 32, respectively, and defining a slit 361 therebetween; and a horizontal connecting wall 33 interconnecting the front and rear walls 31, 32, disposed above the bottom walls 34, 35, and cooperating with the bottom walls 34, 35 to define an accommodating space 36 accessible via the slit 361.

The drawable primary curtain unit 4 includes a fixing section 411 disposed in the accommodating space 36 and extending through the slit 361, an upper curtain section 413 connected to the fixing section 411, a lower curtain section 412 extending downwardly from the upper curtain section 413 and having a light transmittance less than that of the upper curtain section 413, and a primary drawing mechanism 42 for drawing up and lowering the upper and lower curtain sections 413, 412. In the preferred embodiment, the lower curtain section 412 is made of a light-blocking fabric or a fabric with poor light transmittance, and the upper curtain section 413 is made of a screen material. In practice, the object of the present invention can be achieved as long as the upper curtain section 413 is made of a material having a light transmittance greater than that of the lower curtain section 412. In the preferred embodiment, a combined vertical length (L1) of the upper and lower curtain sections 413, 412 is substantially equal to and not smaller than a vertical length of the window 20. A vertical length (L2) of the upper curtain section 413 takes up about 50% of the combined vertical length (L1) In practice, privacy and natural lighting can be achieved at the same time if the vertical length (L2) of the upper curtain section 413 takes up from 25% to 60% of the combined vertical length (L1) of the upper and lower curtain sections 413, 412 depending on requirements of consumers, that is, it is appropriate that a ratio of the vertical length (L2) of the upper curtain section 413 to that of the lower curtain section 412 ranges from 1:3 to 3:2.

The drawable auxiliary curtain unit 5 includes an auxiliary curtain 51 and an auxiliary drawing mechanism 52. The auxiliary curtain 51 is made of a fabric having a light transmittance less than that of the upper curtain section 413, and includes a shielding segment 512 and a fixing segment 511 disposed in the accommodating space 36 and extending through the slit 361 to connect with the shielding segment 512. A vertical length (L3) of the shielding segment 512 is less than the combined vertical length (L1) of the upper and lower curtain sections 413, 412, but is sufficient to ensure that the shielding segment 512 is able to substantially cover the upper curtain section 413 when the shielding segment 512 and the upper curtain section 413 are lowered. Preferably, the vertical length (L3) of the shielding segment 512 is not smaller than that of the upper section 413. Preferably, the vertical length (L3) of the shielding segment 512 is substantially equal to that of the upper curtain section 413.

In this embodiment, the drawable auxiliary curtain unit 5 is disposed relative to the drawable primary curtain unit 4 such that the shielding segment 512 is able to block light passing through the upper curtain section 413 when the shielding segment 512 and the upper curtain section 413 are lowered.

In the preferred embodiment, the primary drawing mechanism 42 is exemplified as a pulling cord unit that includes: a plurality of horizontal rods 421 horizontally disposed on the upper and lower curtain sections 413, 412 and spaced apart from each other; a plurality of rings 422 arranged in two vertical lines and each of which is disposed at a corresponding one of the horizontal rods 421; and a pulling cord 423 strung through the rings 422. The auxiliary drawing mechanism 52 of the auxiliary curtain unit 5 has the same structure as that of the primary drawing mechanism 42. Since the primary and auxiliary drawing mechanisms 42, 52 are conventional, further details of the same will be omitted herein for the sake of brevity.

The roman blind further includes a retaining component 40 for retaining the fixing section 411 of the primary curtain unit 4 and the fixing segment 511 of the auxiliary curtain unit 5 in the accommodating space 36, and a decorative member 6 disposed at an outer surface of the rear wall 32 of the top rail 3. In the preferred embodiment, the decorative member 6 includes a decorative piece 61 used for concealing the upper and lower curtain sections 413, 412 and the auxiliary curtain 51 when they are drawn up, and fastener 62, such as a hook-and-loop fastener, for removably attaching the decorative piece 61 to the top rail 3.

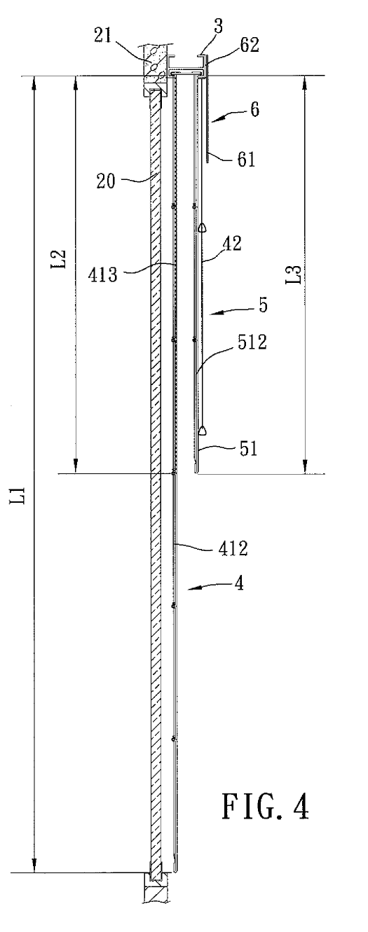

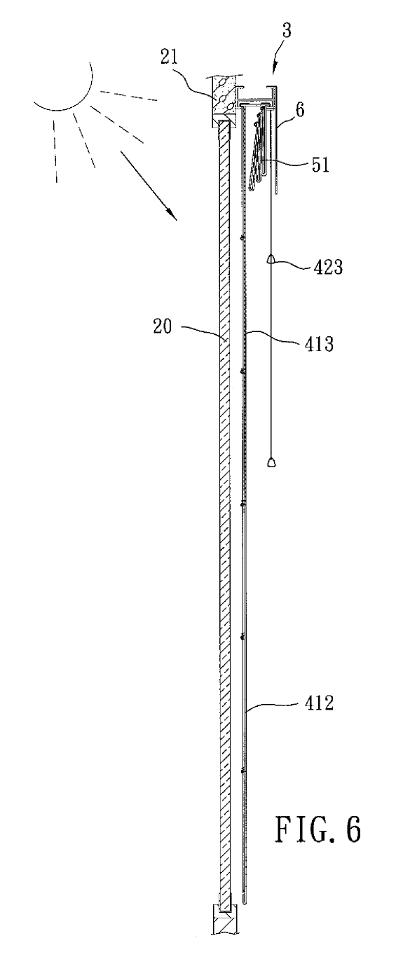

When the shielding segment 512 and the upper and lower curtain sections 413, 412 are fully lowered as shown in FIG. 4, the lower curtain section 412 of the primary curtain unit 4 and the shielding segment 512 of the auxiliary curtain 51 cooperatively block sunlight from passing into a room, because the vertical length (L3) of the shielding segment 512 is sufficient to ensure that the shielding segment 512 is able to substantially cover the upper curtain section 413. Referring to FIGS. 3 and 6, when the auxiliary curtain 51 is drawn up, sunlight can pass through the upper curtain section 413 into the room, and the privacy can be ensured via the lower curtain section 412.

In sum, the window blind assembly according to the present invention has the following advantages. First, a smaller amount of fabric material is needed to manufacture the window blind assembly of the present invention, because the vertical length of the auxiliary curtain 51 is relatively short. Second, it is relatively easy to draw up the shielding segment 512 and the upper and lower curtain sections 413, 412. In particular, because the vertical length of the shielding segment 512 is relatively short and the upper curtain section 413 is made of a screen material, the weights thereof are relatively light. Third, privacy and natural lighting can be ensured at the same time. When sunlight passes through the upper curtain section 413 into the room, the lower curtain section 412 is used to safeguard the privacy in the room.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A window blind assembly comprising:
a top rail;
a drawable primary curtain unit that is hung from said top rail; and
a drawable auxiliary curtain unit that is hung from said top rail and that is disposed at one side of said primary curtain unit;
wherein said drawable primary curtain unit includes an upper curtain section and a lower curtain section that extends downwardly from said upper curtain section and that has a light transmittance less than that of said upper curtain section; and
wherein said drawable auxiliary curtain unit includes an auxiliary curtain that has a light transmittance less than that of said upper curtain section and that has a vertical length less than a combined vertical length of said upper and lower curtain sections, the vertical length of said auxiliary curtain being sufficient to ensure that said auxiliary curtain is able to substantially cover said upper curtain section when said auxiliary curtain and said upper curtain section are lowered.

2. The window blind assembly as claimed in claim 1, wherein the vertical length of said auxiliary curtain is not smaller than that of said upper curtain section.

3. The window blind assembly as claimed in claim 1, wherein the vertical length of said auxiliary curtain is substantially equal to that of said upper curtain section.

4. The window blind assembly as claimed in claim 1, wherein said drawable auxiliary curtain unit is disposed relative to said drawable primary curtain unit such that said auxiliary curtain is able to block light passing through said upper curtain section when said auxiliary curtain and said upper curtain section are lowered.

5. The window blind assembly as claimed in claim 1, wherein the vertical length of said upper curtain section of said primary curtain unit takes up from 25% to 60% of the combined vertical length of said upper and lower curtain sections.

6. The window blind assembly as claimed in claim 1, wherein a ratio of the vertical length of said upper curtain section to that of said lower curtain section ranges from 1:3 to 3:2.

7. The window blind assembly as claimed in claim 1, wherein said upper curtain section is made of a screen material, and said lower curtain section and said auxiliary curtain are made of a light-blocking fabric.

8. The window blind assembly as claimed in claim 1, wherein:
said top rail includes: front and rear walls which extend vertically and which are spaced apart from each other in a front-rear direction, each of said front and rear walls having a bottom edge; two bottom walls extending toward each other from said bottom edges of said front and rear walls, respectively, said bottom walls defining a slit therebetween; and a horizontal connecting wall interconnecting said front and rear walls, disposed above said bottom walls, and cooperating with said bottom walls to define an accommodating space accessible via said slit;
said primary curtain unit further includes a fixing section disposed in said accommodating space and extending through said slit to connect with said upper curtain section;
said auxiliary curtain includes a shielding segment and a fixing segment disposed in said accommodating space and extending through said slit to connect with said shielding segment; and
said window blind assembly further comprises a retaining component for retaining said fixing section and said fixing segment in said accommodating space.

9. The window blind assembly as claimed in claim 1, wherein said primary curtain unit further includes a primary drawing mechanism for drawing up and lowering said upper and lower curtain sections, and said auxiliary curtain unit further includes an auxiliary drawing mechanism for drawing up and lowering said auxiliary curtain.
